(19) United States
(12) Patent Application Publication
(10) Pub. No.: US 2004/0217576 A1
(43) Pub. Date: Nov. 4, 2004

(54) Trailer hitch and tongue alignment system

(76) Inventor: Jeffrey M. Fox, Mokena, IL (US)

Correspondence Address: JoAnne M. Denison, Suite 1608, 212 W. Washington Blvd, Chicago, IL, 60606-3487, US

(21) Appl. No.: 10/427,674

(22) Filed: May 1, 2003

(51) Int. Cl. B60D 1/00

(52) U.S. Cl. 280/477

(57) ABSTRACT

The present invention consists of an improved device for aligning a vehicle trailer hitch to the coupling member of trailer. In one preferred embodiment of the device, a pair of vertical guide rods, one for the vehicle hitch and the other for the trailer coupling member, are provided with gimbal means so that the vertical guide rods remain perfectly vertical, regardless of grade or altitude of the vehicle hitch or trailer coupling member. The trailer hitch guide assembly is provided with a sleeve which may slidingly be received over a ball hitch. A counterweight is disposed at the lower end of the hitch's vertical guide rod. An elongate sleeve is place over the upper portion of the hitch's vertical guide rod and is held in place initially by a small notch located over the hitch ball. A second counter weight is provided for the lower end of the trailer coupling member's guide rod and the trailer coupling gimbal guide assembly is removably secured to the trailer coupling member by means of a magnet and an aperture adapted to slidingly fit over the coupling member. In such a manner, when the trailer hitch ball is in perfect alignment with the coupling member, the elongate sleeve will drop down several inches, revealing a brightly colored guide rod, indicating perfect alignment to the user of the device.

### FIELD OF THE INVENTION

The present invention relates to the field of alignment devices between trailer couplers and vehicle hitches, and more particularly those which work well with only one operator and with market differences in grade between the vehicle and its trailer.

### BACKGROUND OF THE INVENTION

In reviewing the prior art, there exist a wide variety of devices intended to assist a vehicle operator in securing a trailer hitch coupler to a vehicle hitch. Such devices have been in use for years. Typically, most are comprised of either a rod magnetically attached to the vehicle hitch and one on the trailer coupling member, or, a V-shaped bracket is attached to the vehicle hitch or mirror system to view the vehicle coupling unit, a cable and winch mechanism which mounts to the vehicle, and, a remote camera that mounts through the center of the hitch ball with a monitor mounted inside the vehicle. Most commonly, a first pole with a visual cuing device mounted to its top, such as a brightly colored flag or ball is secured adjacent a vehicle's trailer ball hitch, and a second pole with a similar visual cuing device is mounted adjacent the coupling member of the trailer and the driver then steers the vehicle while backing up until the two poles come into visual alignment. Typical examples of such prior art devices are show in the following US Patent documents: U.S. Pat. No. 3,015,162 issued to H. Bohnet; U.S. Pat. No. 3,765,703 issued to F. Voelkerding, etal; U.S. Pat. No. 6,139,041 issued to J. Murphy; and, U.S. Pat. No. 3,889,384 issued to M. White.

An additional interesting patent disclosure in this field of art is U.S. Pat. No. 4,666,176 issued to Sand which also discloses a related device with such a pair of sighting members, with one for the vehicle trailer hitch ball and one for the trailer hitch coupling member, however; a memory device is preferably slidably mounted to either sighting member to record the distance of the coupling member to a common surface. Still yet a further patent disclosure, U.S. Pat. No. 6,341,794 issued to T. Hunter discloses a device wherein the poles for the visual alignment sighting balls are telescoping in nature so that the device may be easily stored by the user thereof.

A further interesting device shown in the prior art is disclosed in U.S. Pat. No. 4,621,432 issued to T. Law in which two guide poles are provided, but one of the guide poles attached to the trailer hitch coupling member actually vibrates when the vehicle hitch is in proper alignment in order to achieve coupling between the two devices.

Still U.S. Pat. No. 6,517,098 disclose interesting C-shaped and U-shaped bracket members which allow a standard visual cuing poles to be attached to the vehicle trailer hitch ball and the coupling element provided on a typical trailer.

Other patent disclosures of interest disclose fork like or V-shaped bracket members for aligning the trailer coupling as a vehicle is back up into. Such devices are disclosed in U.S. Pat. No. 4,560,183 issued to C. Cook; and, U.S. Pat. No. 4,708,359 issued to D. Davenport. The main problem with the V-shaped brackets which are attached to the vehicle coupling members is that there is no visual reference from the driver's position. Due to the large margin for error in vertical and horizontal alignment, there exists a large chance of the coupling misaligning with the receiver ball while backing the vehicle up to the trailer, resulting in the coupling impacting the vehicle's rear bumper, causing damage to the vehicle and the trailer. There are currently several different models of this type on the market. Most of these models require various degrees of setup that are unique to each vehicle and trailer. The setup involved does not allow the user to quickly use this device on any other types of vehicles or trailers without the required specialized setup. This type of device still requires two people to operate safely and effectively.

U.S. Pat. No. 5,669,621 also discloses a pair of sighting poles with flags mounted to the top of each of the poles, but this trailer hitch alignment device is further provided with a weighted pivoting assembly mounted to its flag poles such that the flog pole will visually pivot indicating proper alignment has been achieved.

A further patent document disclosure of interest is U.S. Pat. No. 5,558,352 issued to M. Mills which discloses the use of a trailer hitch alignment device having a pair of poles with flags removably mountable to a trailer coupling member and a ball hitch wherein the means to removably mount these two poles with flags comprises velcro-type straps and magnets.

It should be noted that the main problem with the magnetically attached rods is that they do not compensate for any variation in grade or angle of approach. This results in a large margin of error, both vertical and horizontal, for centering the coupling over the receiver ball. The efficiency of this device degrades rapidly the greater the angle of approach and with any deviation in grade. Another problem with such devices, is obtaining the proper location for attachment of such devices to the vehicle and the trailer due to the variation of the trailer and hitch equipment available. Due to the large margin for error in vertical and horizontal alignment there exist a large chance of the coupling mis-aligning with the receiver ball while backing the vehicle up to the trailer resulting with the coupling impacting the vehicle's rear bumper causing damage to the vehicle and the trailer. This type of device still requires two people to operate safely and effectively. There are currently several different models of this type on the market. Most of these models require various degrees of setup that are unique to each vehicle and trailer. The setup involved does not allow the user to quickly use this device on any other vehicles and trailers without the required setup.

The main problem with a cable and winch system is the extensive installation required. Once such a system is mounted, it cannot be used on another vehicle. This system will only function properly when pulling the trailer from level ground or uphill, inasmuch as pulling the trailer downhill may cause the trailer to roll down grade uncontrollably.

The main problem with a remote camera and monitor system is the extensive installation and cost required. Similarly, once this system is installed, it would be difficult or impossible to install it on another vehicle.

Thus, although there are quite a few disclosures in the prior art relating to trailer hitch and coupling member type devices, none disclose a system which utilizes gimbaled elements in order to allow the device to be safely utilized by only one individual on differing grades between the vehicle and the trailer and in even very low light conditions.

### SUMMARY OF THE INVENTION

The present invention consists of two separate assemblies; one of which is secured to a trailer hitch ball, while the second is secured to the trailer coupling member. Each assembly comprises a rod that runs through a gimbal which has a counterweight on the its lower end to maintain the rod in a vertical position at all times. The gimbal assembly is provided with an inner ring with a small diameter interior rod traversing its midsection. The small diameter rod runs perpendicular to the vertical rod. Also provided are two short rubber tubes which cover the small diameter rod on either side of the vertical rod. These small diameter tubes are intended to dampen excessive movement. The inner gimbal ring is attached to an outer gimbal ring by means of two short exterior rods set perpendicularly from the interior gimbal rod. There are two small rubber bushings placed on the outer rods between the inner and outer gimbal rings which are additionally provided to dampen excessive movement.

The trailer coupling gimbal assembly attached to the trailer coupling element by means of an L-shaped bracket. The L-shaped bracked is provided with a flat round magnet on its lower surface. The fat round magnet is further provided with a thin round bushing which protrudes from the top which in turn fits into the coupling opening from the bottom of the device. The busing enables the L-shaped bracket to be centered in the opening that the hitch trailer ball is adapted to fit within. The L-shaped bracket further is capable of pivotal rotatation about an integral pivot point which is located near the bottom of the device and is further secured by a retainer element. Also provided in this device is a flat swing arm which is attached to a second integral pivot point located near the upper portion of the L-shaped bracket and which is secured with a second retainer element. The combination of the swing arm and the pivot point enables the vertical rod on the trailer coupling gimbal guided assembly to be positioned vertically directly over the center of the coupling aperture regardless of the grade or altitude of the trailer. A contact plate is further secured to the bottom of the flat round magnet.

A vehicle hitch gimbal guide assembly is also provided for the vehicle hitch in a similar manner. Vehicle hitch gimbal assembly is provided with a gimbaled assembly which is secured to the hitch ball by means of an annular sleeve which is capable of slidingly attaching to the hitch ball in a simple and uncomplicated maneuver by the user of the device. A gimbal assembly is also provided and is positioned perpendicularly to the receiver and is secured to a pivot pint with a retainer which allows this assembly to automatically adjust itself for grade. A similar vertical rod is provided with two L-shaped bends along its length which enable the rod to be positioned along the vehicle's centerline. The vehicle vertical rod has a counterweight attached to its lower end. The vehicle vertical rod is further provided with a notch located just below the top of the hitch ball. Also provided is a thin tube which slidingly engages with the vehicle vertical rod. This tube is set directly upon the notch. The top portion of the tube is in line with the top of the vertical rod when the tube is set on the notch. The slide tube is secured with a retainer key which prevents the tube from rotating about the vehicle vertical rod.

In such a manner, once both hitch and trailer devices are in position the driver of the vehicle back up in reverse while looking through the rear view mirror of the vehicle. The driver then backs up, keeping both vertical shafts in alignment. As the hitch ball comes directly under the center of the trailer coupling, the contact plate will contact the tube on the hitch assembly and become dislodged from the notch and will descend several inches, allowing the top of the hitch assembly rod to become visible. In one preferred embodiment of the invention the hitch assembly rod upper portion is brightly colored and thus is readily visible to the vehicle drive. Then, when the vehicle is in position, the trailer coupling member will be in a ready position to be installed onto the trailer ball hitch.

### OBJECTS OF THE INVENTION

Thus, it is one primary object of the present invention to provide a vehicle hitch guide assembly which is provided with two gimbals, one on the trailer coupling guide assembly and the other on the vehicle hitch guide assembly wherein the gimbals communicate with guide rods such that when the two guide rods are in alignment, an outer elongate sleeve descends revealing a brightly colored upper rod portion indicating the driver of the vehicle may stop because the trailer coupling member may be readily attached to the vehicle trailer hitch ball.

It is a further primary object of the present invention to provide a vehicle hitch guide assembly which is provided with two gimbals, one on the trailer coupling guide assembly and the other on the vehicle hitch guide assembly wherein the gimbals communicate with guide rods and the gimbals align the guide rods vertical at all times, despite either the vehicle and/or the trailer being driven or present on an uneven or sloped surface.

Yet an additional primary object of the present invention to provide a vehicle hitch guide assembly which is provided with two gimbals, one on the trailer coupling guide assembly and the other on the vehicle hitch guide assembly wherein a swing arm on the trailer guide assembly is provided with a pivot point where it can rotate about an axis point until it is perfectly in line with a corresponding guide rod provided on the vehicle hitch guide assembly.

Still a further primary object of the present invention to provide a vehicle hitch guide assembly which is provided with two gimbals, one on the trailer coupling guide assembly and the other on the vehicle hitch guide assembly wherein the lower portion of the trailer coupling guide assembly is provided with a magnet to facilitate the descent of the guide rod when the vehicle and the trailer are in proper position to be coupled together.

Yet an additional primary object of the present invention to provide a vehicle hitch guide assembly which is provided with two gimbals, one on the trailer coupling guide assembly and the other on the vehicle hitch guide assembly wherein

These and other objects and advantages of the present invention can be readily derived from the following detailed description of the drawings taken in conjunction with the accompanying drawings present herein and should be considered as within the overall scope of the invention.

### BRIEF DESCRIPTION OF THE DRAWINGS

FIG. 1 is an elevated side view of the gimbaled trailer guide assembly.

FIG. 2 is an elevated cross section taken along line A-A of FIG. 1 showing the gimbal assembly of FIG. 1.

FIG. 3 is a an elevated side view of the gimbaled vehicle guide assembly.

FIG. 4 is a is an elevated cross section taken along line B-B of FIG. 2 showing the gimbal assembly of FIG. 3.

### DETAILED DESCRIPTION OF THE DRAWINGS

Shown in FIG. 2 is trailer coupling gimbal guided assembly 10 which consists of gimbal assembly 30 which is used to keep vertical guide rod 20 perpendicular to the ground at all times, even when the ground is sloped. The vertical guide rod 20 communicates with a counterweight 32 at its lower end. A swing arm 36 is further provided and is retained by two retainer elements 34, one positioned at its upper end and the other positioned at its lower end. The trailer coupling element attaches to trailer coupling gimbal guided assembly by means of L-shaped bracket 38. The L-shaped bracket 38 is further provided with a flat round magnet 44 at its lower end. The trailer coupling gimbal guide assembly 10 mounts to the bottom of the trailer coupling member by means of flat round magnet 44 which has annular bushing 42 dimensioned the some size as the trailer member coupling opening. Protruding above the flat round magnet 44 is annular bushing 42 which fits into the bottom of L-shaped bracket 38. The annular bushing 42 enables the L-shaped bracket 38 to be centered in the aperture that the hitch receiver ball fits into. The combination of the swing arm 36 and the pivot point 40 enables the vertical guide rod 20 to be positioned vertically directly over the center of the coupling opening, regardless of grade or altitude of the trailer. A contact plate 46 is further secured to the underside of flat round magnet 44.

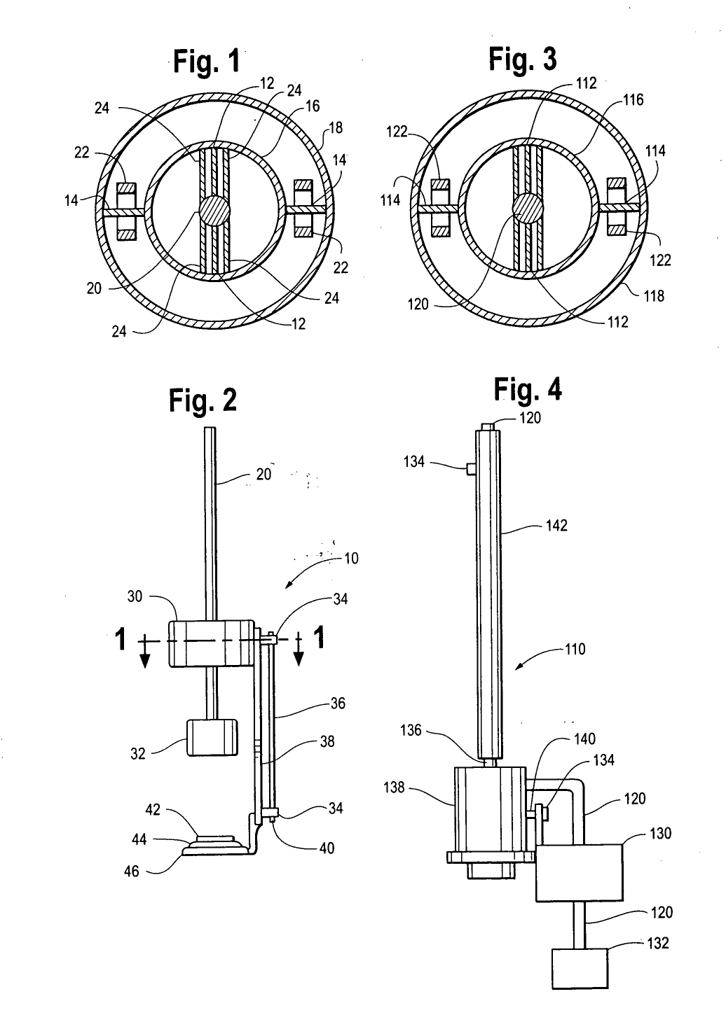

FIG. 1 is a cross section of gimbal assembly 30 taken along line A-A and it shows the inter details of this device. Inside gimbal assembly 30 is inner gimbal ring 12 which communicates with exterior gimbal ring 18 by means of a pair of opposing short, slender diameter rods, exterior gimbal rods 14. Similarly, interior gimbal ring 16 communicates with vertical guide rod 20 to maintain perfectly vertical positioning at all times by means of a pair of opposing slim interior gimbal rods 12. In order to dampen excessive movement, a pair of interior rubber bushing tubes 24 are disposed around exterior gimbal rods 14. Similarly, a pair of exterior rubber busing rubber bushing tubes 22 are disposed about exterior gimbal rods 14.

FIG. 4 depicts in detail vehicle hitch gimbal guide assembly 110 which is provided for attachment to the vehicle hitch. In a similar manner, gimbal assembly 130 keeps vertical guide rod 120 perpendicular to the ground at all times, even where a sloping grade is present. Vertical guide rod 120 is provided with two 90° bends along its length, one between the gimbal assembly 130 and slide tube or sleeve 138, and the other between this first bend and guide rod sleeve 142. The two bends allow vertical guide rod 120 to be positioned along the centerline of the vehicle. The vertical guide rod 120 has a counterweight 132 depending from its lower end. A notch 136 is also provided in vertical guide rod 120 which is located just below the top of the hitch ball. A guide rod sleeve or tube 142 is placed over vertical guide rod 120 to cover the exterior of vertical guide rod 120, which is intended to be pointed a color of high visibility. A retainer key 134 is further provided to prevent the guide rod sleeve 142 from rotating about vertical guide rod 120 when the device is in use.

A slide tube 138 is provided so that the user of the device may removably install slide tube 138 over the trailer hitch when the device is intended to be used. Vehicle hitch gimbal guide assembly 110 is also provided with a pivot point 140 and a retainer 134 which secures gimbal assembly 130 to slide tube 138.

When both the vehicle hitch gimbal guide assembly 110 and trailer coupling gimbal guide assembly 10 have been properly removably installed onto a vehicle trailer hitch and its corresponding trailer coupling member, the device may be used. The driver may then back up the vehicle in reverse while looking through his rear view mirror. The object is simply to keep the vertical guide rods 20 and 120 in proper alignment. As the hitch ball comes directly under the center of the trailer coupling, the contact plate 46 will contact the guide rod sleeve 142 on the vehicle hitch guide assembly 110 and become dislodged from the notch 136 and will drop several inches. At this point, the top of vertical guide rod 120 will become readily visible indicating that the hitch ball is centered directly under the trailer coupling member. At this point, the vehicle is stopped and both the trailer coupling gimbal guide assembly 10 and the vehicle hitch gimbal guide assembly 110 may be removed and the user simply lowers the coupling onto the now properly aligned hitch ball.

Although in the foregoing detailed description the present invention has been described by reference to various specific embodiments, it is to be understood that modifications and alterations in the structure and arrangement of those embodiments other than those specifically set forth herein may be achieved by those skilled in the art and that such modifications and alterations are to be considered as within the overall scope of this invention.

What is claimed is:

1. A vehicle hitch guide assembly and a trailer coupler guide assembly having a vehicle hitch, a trailer coupling member, a hitch guide rod and a trailer coupling member guide rod, two gimbal means communicating with each guide rod, an elongate sleeve covering the hitch guide rod, a notch on the hitch guide rod to support the elongate sleeve when the device is initially in use, a contact member on the trailer coupling member, wherein when the contact member comes in contact with the elongate sleeve, it will dislodge it from the notch and the sleeve will drop downwardly, indicating that a vehicle is in proper position to couple a vehicle hitch to the trailer coupling member.

2. The guide assembly according to claim 1 wherein at least a portion of the the hitch guide rod is brightly colored so that when the elongate sleeve is dislodged, it will reveal to the user a visually bright color indicating that a vehicle is in proper position to couple a vehicle hitch to the trailer coupling member.

3. The guide assembly according to claim 1 wherein the trailer coupling guide assembly further has a swing arm and a trailer coupler by is removably secured to the trailer coupling guide assembly means of the swing arm.

4. The guide assembly according to claim 1 wherein the hitch guide assembly is further provided with a sleeve which may slidingly and removably engage with a trailer hitch ball.

5. The guide assembly according to claim 1 wherein the gimbal means comprise an outer ring and an inner ring, and a pair of opposing rods disposed between the outer ring and the inner ring, a second pair of opposing rods are further disposed between the vertical guide rod and the inner ring such that the vertical guide rod perpetually remains perpendicular to the ground, even where the vehicle or trailer is place on sloped ground.

6. The guide assembly according to claim 1 wherein each of the opposing rods disposed between the outer ring and the inner ring are further provided with a rubber tube bushing to dampen any excessive movement.

7. The guide assembly according to claim 6 wherein each of the opposing rods disposed between the vertical guide rod and the inner ring are further provided with a rubber tube bushing to dampen any excessive movement.

8. The guide assembly according to claim 1 wherein magnet means is also provided in the trailer coupling guide assembly so that the trailer coupling guide assembly may be removably attached to a trailer coupling member.

9. The guide assembly according to claim 8 wherein the a bushing adjoins the magnet means and the bushing is adapted to fit and secure to a trailer coupling opening of substantially the some dimension.
